(19) United States
(12) Patent Application Publication
(10) Pub. No.: US 2024/0275620 A1
(43) Pub. Date: Aug. 15, 2024

(54) BLOCKCHAIN RESOURCE MANAGEMENT SYSTEM AND METHOD OF USE

(71) Applicant: BlockJoy, Inc., Boston, MA (US)

(72) Inventors: Christopher Bruce, Boston, MA (US); Sean Carey, Boston, MA (US)

(73) Assignee: BlockJoy, Inc., Boston, MA (US)

(21) Appl. No.: 18/440,118

(22) Filed: Feb. 13, 2024

Related U.S. Application Data
(60) Provisional application No. 63/445,118, filed on Feb. 13, 2023.

(51) Int. Cl. H04L 9/00

(52) U.S. Cl. CPC H04L 9/50

(57) ABSTRACT

In variants, systems and methods for managing a set of blockchain resources can include, for each of a set of managed blockchain resources, each including a blockchain node hosted on a machine: determining a machine state of the machine; determining a node state of the node; and managing the blockchain resource based on the machine state and the node state, wherein the machine is not restarted when the machine is offline but the node is online. In examples, the machine state and node state can be determined using different communication channels.

### CROSS-REFERENCE TO RELATED APPLICATIONS

This application claims the benefit of U.S. Provisional Application No. 63/445,118 filed 13 Feb. 2023, each of which is incorporated in its entirety by this reference.

### TECHNICAL FIELD

This invention relates generally to the blockchain field, and more specifically to a new and useful blockchain resource monitoring system in the blockchain field.

### BACKGROUND

When running a blockchain node, it is oftentimes important to monitor the availability of the blockchain node, since an offline blockchain node can result in functional loss (e.g., become unsynchronized from other blockchain nodes, miss an opportunity to participate in consensus or to mine blocks). Even though blockchain nodes each run on a networked machine, such as a machine, conventional network monitoring methods are insufficient at solving this problem, since the machine may appear to be offline due to connectivity or relay issues (e.g., internet service provider (ISP) issues, domain name system (DNS) resolution errors), etc.), while the node is still online and connected to the blockchain. Restarting the machine in these situations can create node participation issues within the blockchain network. For example, shutting off the node during consensus participation can cause the node to lose the ability to participate in the blockchain consensus round, and may result in node penalization. In another example, starting another instance of the node can inadvertently create multiple peer addresses that are associated with the same validation key, which can cause the blockchain to penalize all of the nodes associated with said validation key.

Thus, there is a need in the blockchain field to create a new and useful system and method for monitoring and managing

### BRIEF DESCRIPTION OF THE FIGURES

FIG. 1 depicts a schematic representation of a variant of the method.

FIG. 2 depicts a schematic representation of a variant of the blockchain resource monitoring architecture.

FIG. 3 depicts an illustrative example of data transfer between components of the blockchain resource monitoring architecture.

FIG. 4 depicts an illustrative example of determining the machine state and a first and second illustrative example of determining the node state.

FIG. 5 depicts an illustrative example of determining machine state using applications hosted by the machine.

FIG. 6 depicts examples of monitoring the blockchain resource.

### DETAILED DESCRIPTION

The following description of the embodiments of the invention is not intended to limit the invention to these embodiments, but rather to enable any person skilled in the art to make and use this invention.

### 1. Overview

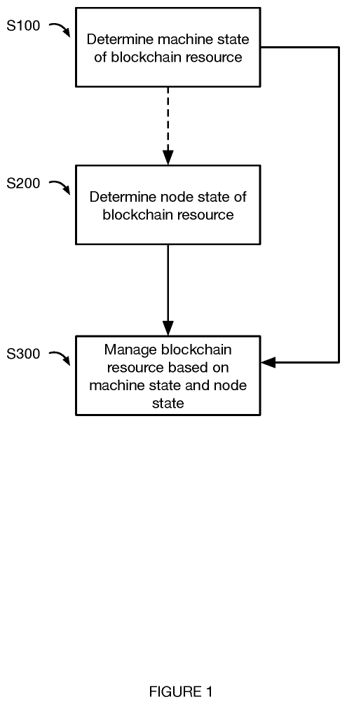

As shown in FIG. 1, in variants, a blockchain resource monitoring method can include: determining a machine state of a blockchain resource S100; determining a node state of the blockchain resource S200; and managing the blockchain resource based on the machine state and the node state S300. The method functions to account for the node state (e.g., node connectivity to the respective blockchain) in making resource management decisions.

In an example, the method can include: determining whether the machine of the blockchain resource is accessible (e.g., online) by sending a message to the machine running the blockchain node using an internet protocol (e.g., ICMP message, a transport protocol, etc.); determining whether the node of the blockchain resource is accessible (e.g., online) using an element of the node's blockchain (e.g., a lightweight call from the node's blockchain protocol that generates a response from the node, the blockchain's peer book, inferring whether the node is connected from the node's telemetry, etc.); and selectively managing the blockchain resource based on the machine state and the node state. For example, when both the machine and the node are inaccessible (e.g., offline), the entire blockchain resource can be restarted by restarting the machine (e.g., server). In another example, when the machine is accessible (e.g., online) but the node is inaccessible (e.g., offline, not connected to the blockchain), the system can restart the node without restarting the machine (e.g., by instructing a client or daemon executing alongside the node on the machine to shut down and restart the node) or shut down and restart the node on a different machine. In a third example, when the machine is inaccessible (e.g., offline) but the node is accessible (e.g., online, connected to the blockchain, etc.), the system can: not restart the blockchain resource (e.g., wait for the machine to become available); restart the daemon executing on the machine alongside the node (e.g., via a programmatic connection to the machine's datacenter, such as an IPMI), wherein the daemon determines and/or communicates machine availability; upon continued failure to connect to the machine, optionally confirm that the node is not about to enter consensus (e.g., based on blockchain elements for the node's blockchain, such as the list of addresses participating in the next consensus round), and restart the blockchain resource; and/or otherwise manage the blockchain resource. In a fourth example, when both the machine and the node are accessible, the system can continue to monitor the blockchain resource (e.g., periodically test the machine and/or node accessibility). However, the blockchain resources can be otherwise managed.

### 2. Technical Advantages

Variants of the technology can confer benefits over conventional systems.

For example, variants of the technology can account for node connectivity to the blockchain (e.g., the node's peer network) before taking actions that would shut down the node or disconnect the node from the blockchain. In a first example, this can prevent the node from being shut off during consensus participation. In a second example, this can prevent multiple nodes associated with the same validation key (e.g., private key) from being created, which prevents the blockchain protocol from discounting, removing, or otherwise penalizing the validation key. This, in turn, can increase the node participation in blockchain events, such as consensus (e.g., mining, transaction or block validation, etc.). In a third example, this can prevent the node from losing consensus priority. In a fourth example, this can ensure that transactions, requests, or other blockchain messages sent via the node are broadcast to the remainder of the blockchain network. In a fifth example, this can ensure that the node is synchronized with the remainder of the blockchain.

However, further advantages can be provided by the system and method disclosed herein.

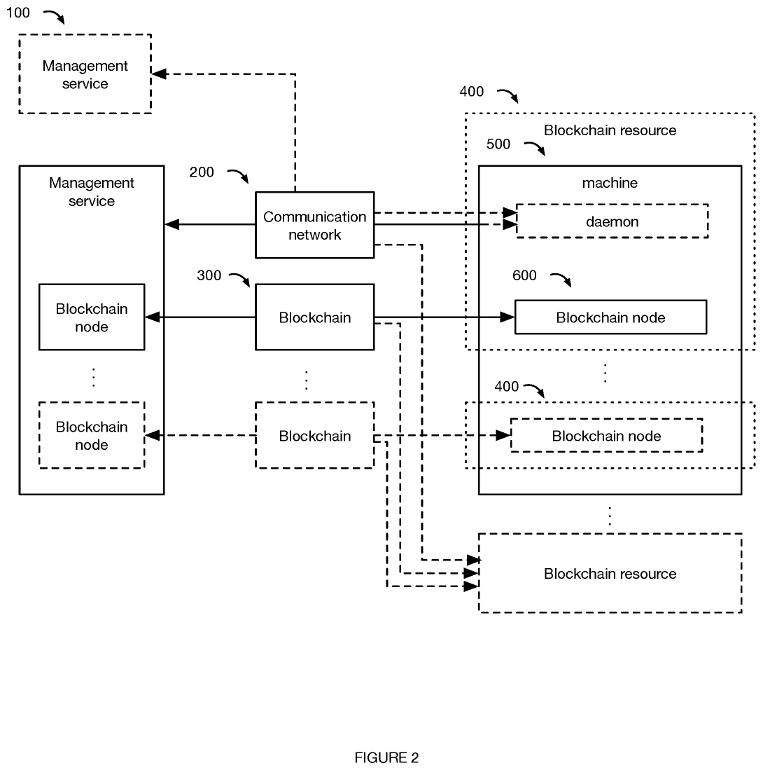

As shown in FIG. 2, variants of the method can be used with one or more: blockchain resources 400, management services 100, and/or any other suitable system.

Each blockchain resource 400 functions to connect to and perform functionalities for one or more blockchains. The blockchain resources are preferably hosted resources that are managed (e.g., by the management service) on behalf of one or more users (e.g., wherein the user does not directly manage the blockchain resources); alternatively, users can directly manage the blockchain resources.

The method can concurrently manage one or more blockchain resources 400. The multiple blockchain resources can be for the same or different blockchain. The multiple blockchain resources can be owned by the same or different entities. Different blockchain resources can share a machine (e.g., be hosted by or run on the same machine), be collocated (e.g., be part of the same server cluster), be distinct (e.g., not share the same machine), be remote from each other, and/or be otherwise related. Different concurrently-operating blockchain resources are preferably associated with different validation keys (e.g., private keys), but can additionally or alternatively be associated with different public keys, different blockchain addresses, and/or other blockchain identifier. However, different concurrently-operating blockchain resources can be associated with the same validation keys or addresses.

A blockchain resource 400 can include a machine 500, a blockchain node 600, and/or any other suitable component (e.g., example shown in FIG. 2).

Each machine 500 functions as the hardware that executes, runs, hosts, or otherwise supports the blockchain node.

The machine 500 is preferably part of a datacenter (e.g., managed by a third party, such as Amazon™, Microsoft™, Google™, and/or other computing service provider), but can alternatively be part of a cluster, be a standalone machine, and/or be otherwise physically managed. The machine can be physically controlled via a programmatic out-of-band machine management system (e.g., different from the management service), such as an Intelligent Platform Management Interface (IPMI) (e.g., implemented by the physical machine management system, such as the datacenter); be manually controlled (e.g., via a set of machine operator notifications and/or endpoints); and/or be otherwise physically controlled. The machine can additionally or alternatively be digitally controlled by the programmatic out-of-band machine management system; be remotely controlled by the management service via an application running on the machine (e.g., the daemon); and/or otherwise virtually controlled. Each machine can be identified by: an IP address, a domain name, and/or otherwise identified.

The machine 500 is preferably physical, but can alternatively be virtual. Examples of machines that can be used include servers, computers, user devices, and/or other machines. The machines can include processing systems (e.g., GPUs, CPUs, TPUs, ASICs, etc.), memory (e.g., non-volatile memory, volatile memory, etc.), and/or other components. Each machine can include different processor types (e.g., CPU, GPU, TPU, IPU, ASIC, etc.) and/or numbers thereof, different memory types and/or numbers thereof, and/or otherwise vary. Alternatively, the machines can all be the same. The machines can be geographically distributed (e.g., across different countries, continents, regions, etc.), and/or be otherwise related.

Each blockchain resource 400 is preferably associated with a single machine, but can alternatively be associated with multiple machines (e.g., a distributed blockchain resource, a node that is run on multiple machines, etc.). The method preferably concurrently manages multiple machines, but can alternatively concurrently manage a single machine.

Each machine 500 can run (e.g., host, execute, etc.) one or more blockchain nodes (e.g., example described in U.S. application Ser. No. 18/190,259 filed Mar. 27, 2023, incorporated herein in its entirety by this reference). The multiple blockchain nodes executing on a single machine can be for the same or different blockchain. The multiple blockchain nodes executing on a single machine can be for the same or different user. The multiple blockchain nodes executing on a single machine are preferably associated with different validation keys (e.g., different private keys), but can additionally or alternatively be associated with the same validation keys. The different blockchain nodes running on the same machine can be partitioned within different computing environments (e.g., container, virtual machine, etc.) within the machine, can share the same computing environment, can run on the same or different threads, and/or otherwise share the machine's computing resources. Each blockchain node running on the shared machine can be associated with a different blockchain resource (e.g., wherein multiple blockchain resources share a common machine), or be associated with the same blockchain resource.

Each machine 500 can also run (e.g., host, execute, etc.) one or more daemons (e.g., client, machine client, service client, application, service, etc.) that functions to locally implement commands from the management service (e.g., monitoring service). For example, the daemon can monitor machine operation (e.g., generate machine operation logs), monitor node operation (e.g., of the one or more nodes), control machine operation (e.g., shut down the machine, start or stop a computing environment, etc.), control node operation (e.g., shut down the blockchain node, start a blockchain node, etc.), communicate with the management service (e.g., respond to internet protocol messages), maintain a communication channel (e.g., an open socket connection) with the management service, and/or perform other functionalities. The daemon preferably runs alongside the blockchain node(s) (e.g., in the same computing environment), but can alternatively run in a different computing environment, different process, different thread, or otherwise different resource on the machine. The daemon can be only accessible by the management service (e.g., require management service login information, authentication keys, signature, or other authentication before responding to a request), but can additionally or alternatively be accessible by a machine management entity (e.g., the datacenter operator) and/or by any other suitable entity.

However, any other suitable machine can be used.

A machine 500 can be associated with a machine state, which can be indicative of the machine's operation (e.g., offline, running, paused, etc.), machine's accessibility (e.g., accessible or online, inaccessible or offline, etc.), and/or other machine metric. The machine accessibility can be the machine's accessibility via the communication network, via the blockchain network(s), via a tertiary network (e.g., peer network, wireless network, cellular network, etc.), via the computing service provider (e.g., via a hardwired connection), and/or accessibility via any other suitable communication channel. The machine state can be determined by one or more: management service instances (e.g., whether the management service can access the machine), blockchain resources (e.g., managed by the management service), user devices, third parties, and/or other systems. The system determining the machine state is preferably remote from the machine, but can alternatively be colocalized with the machine (e.g., located within the same server center, running on the machine, etc.). When the machine state is determined based on information from multiple systems, the machine state can be determined by: voting on the machine state value, trusting a single system's machine state determination, and/or otherwise determining the machine state value.

The machine state can be determined based on: whether the machine responds to a request or establishes a connection (e.g., whether a program executing on the machine, such as the operating system, a component executing an internet protocol suite, the daemon, or the node, responds to the request); based on the information contained within the machine's response (e.g., whether the information matches expected data, whether the information was from a predetermined timeframe, etc.); based on machine event log information (e.g., process execution history, access history, file access history, crashes, system changes, startup messages, etc.); and/or based on any other suitable machine information. The machine can be considered accessible (e.g., online) when a response to a request is received, when the received information or machine log information satisfies a set of conditions (e.g., matches expected information, has a timestamp within a threshold duration from a current timestamp, etc.), or when any other suitable condition is met. The machine can be considered inaccessible (e.g., offline) when no response is received, when a response is received outside of a predetermined timeframe (e.g., after 1 minute has passed), when the round trip time exceeds a threshold duration, when the received information or machine log information does not satisfy a set of conditions, and/or when any other suitable condition is met.

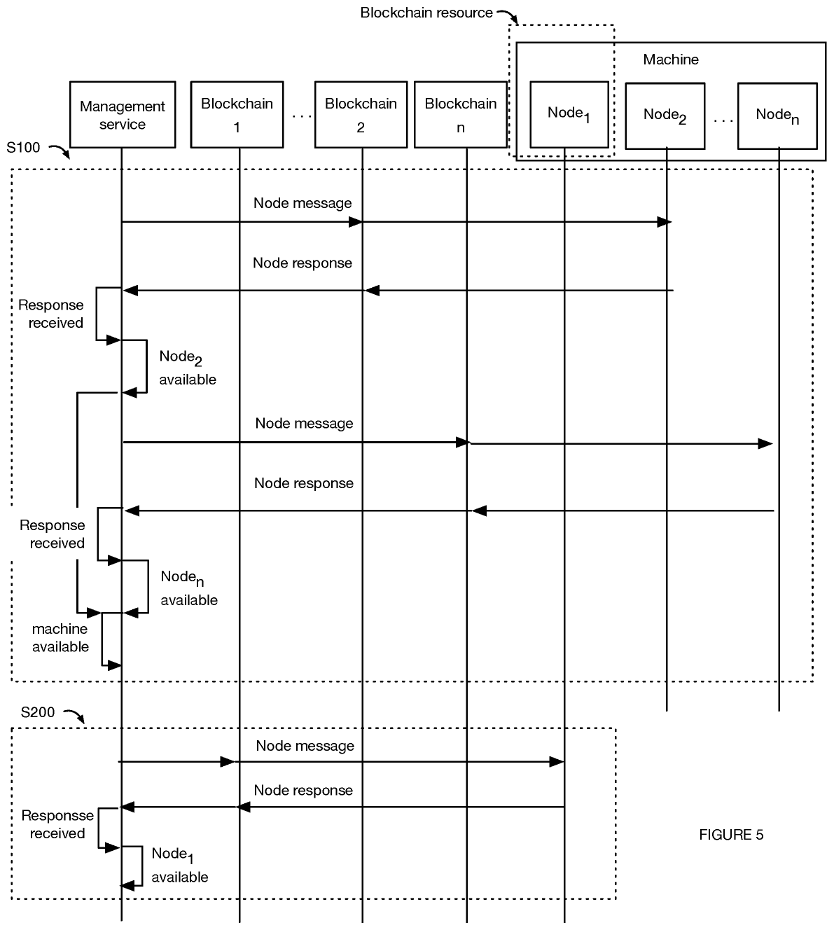

In a first example, the machine state can be determined by pinging the machine (e.g., sending an ICMP echo request and awaiting a response) or sending a message via the transport layer of the communication network and awaiting a response. In a second example, the machine state can be determined by sending a request to the machine (e.g., an application executing on the machine) and awaiting the response. for example, the machine can be considered accessible when a daemon running on the machine responds to a request. In a third example, the machine state can be determined by sending messages to other nodes executing on the same machine (e.g., using the other nodes' respective blockchain messaging protocols). For example, when the machine runs multiple nodes connected to different blockchains, the machine can be considered accessible when messages are received by one or more of the multiple nodes (e.g., the messages appear on the nodes' respective blockchains) and/or one or more of the multiple nodes perform operations called by the management service (e.g., posting messages, sending transactions, staking assets, etc.), example shown in FIG. 5. In this example, the communication pathway to send the call from the management service to the node can at least partially rely on the communication network, or be otherwise related to the communication network. In a fourth example, the machine state can be determined by sending a message to broadcast a blockchain message using the node to the daemon or another application executing on the machine, and determining whether the message appears on the blockchain. In a fifth example, the machine state can be determined by evaluating the machine log information (e.g., determining whether machine events associated with machine availability are detected, determining whether the machine is operating as expected, determining whether the last machine event occurred within an expected timeframe, etc.). In a sixth example, the machine state is determined by the daemon executing on the machine. In an illustrative example, the daemon can send a request to a remote device (e.g., management system, another blockchain resource, another endpoint, etc.) and consider the machine available when a response is received; evaluate whether external data is being received on a machine connection port; or otherwise determine the machine's accessibility state. However, the machine accessibility can be otherwise determined.

However, the machine state can be otherwise determined.

Each machine 500 can be connected to a communication network 200. The communication network can communicatively connect the machines together, connect the machines to the management service, connect applications running on the machines (e.g., the daemons, the nodes, etc.) to the management service, connect one or more blockchain resources together, connect blockchain nodes together (e.g., of the same blockchain network, function as the communication infrastructure for a blockchain, etc.), and/or connect the machines to other endpoints.

The communication network 200 can be formed from one or more connected machines (e.g., blockchain resource machines, non-blockchain resource machines, etc.), relays, routers, and/or other devices that cooperatively form the physical layer of the communication network. The communication network can connect one or more edge devices with each other. Edge devices can be: communication endpoints, devices that are not intermediary devices within the communication network (e.g., do not relay communication network information), and/or be otherwise defined. The blockchain resource machines are preferably edge devices, but can additionally or alternatively be intermediary devices (e.g., that relay communication network information).

The communication network 200 can be managed by Internet Service Providers (ISPs), internet access providers, internet transit providers, domain name systems (DNS), peers, and/or other entities.

The communication network 200 is preferably separate (e.g., distinct) from the blockchain network (e.g., uses different intermediary devices that connect the management service to the blockchain resource machine), but can additionally or alternatively partially or entirely overlap with the blockchain network (e.g., share intermediary devices that connect the management service to the target machine). In the latter variant, the communication network preferably uses a different communication protocol from the blockchain network, but can additionally or alternatively use the same protocol.

Examples of communication networks 200 that can be used include the Internet, a mesh network, an offchain network, a secondary blockchain network (e.g., different from the nodes' blockchain), or other network. The method can be used with one or more communication networks. All machines of the set of monitored blockchain resources are preferably connected to the same communication network, but can alternatively be connected to different communication networks. All machines of the set of monitored blockchain resources are preferably connected to the management service using the same communication network, but can alternatively be connected to the management service using different communication networks.

The communication network 200 can use one or more protocols to communicate information between the devices of the network. Examples of protocols that can be used include TCP/IP, peer-to-peer protocols, mesh protocols, and/or other protocols. The protocols can include one or more layers, such as application layers (e.g., that enables communication with host-based and user-facing applications), presentation layers (e.g., that functions as the data translator for the network), session layers (e.g., that provides the mechanism for opening, closing and managing a session between end-user application processes), transport layers (e.g., that provide end-to-end communication services for applications), network layers (e.g., that transfers variable-length network packets from a source to a destination host via one or more networks), link layers (e.g., that transfers data between nodes of the communication network), and/or other layers.

The communication network 200 can enable messages to be sent to the machines themselves, to applications running on the machines (e.g., the daemon, the node, etc.), and/or any other suitable endpoint associated with the machine. In variants, the method can use these messages to determine whether a machine is available (e.g., connected to the communication network), to send instructions to the machine, and/or otherwise utilize the messages. For example, a machine can be considered available when the machine or application running on the machine responds to a request, and be considered unavailable when the machine or application running on the machine does not respond to the request within a threshold period of time. The messages can be sent by: the management service, a blockchain resource machine, a non-blockchain resource machine, an application (e.g., a node, a daemon, etc.) executing on a separate machine, and/or by any other suitable sender. The messages can be sent on: the network layer, the transport layer, the session layer, the presentation layer, the application layer, and/or any other suitable layer of the communication network protocol. The messages can be provided by the communication network protocol, by an application executing on the machine, or by any other suitable protocol or library. The messages can be solely to test for machine availability on the communication network (e.g., not carry any additional information aside from availability metrics), can carry information in addition to machine availability information (e.g., include a machine operation command, a node operation command, etc.), and/or include any other suitable information. Examples of messages include requests, responses, and/or other messages. Examples of messages that can be used include: ping (e.g., ICMP echo requests, wherein the target machine can send an ICMP echo reply), other transport layer messages, server access requests (e.g., requests to access the node, the daemon, or another application running on the machine), traceroute commands (e.g., that trace the connection to the machine), commands for applications running on the machine (e.g., daemon commands, node commands, etc.), and/or other messages.

However, any other suitable communication network can be used.

Each node 600 (e.g., blockchain client) functions as an interface to the respective blockchain network. The technology can be used with one or more blockchain networks and/or subnets (e.g., mainnet, testnet, validation networks, etc.). The blockchain networks can be account-based blockchains (e.g., Ethereum, EOS, Tron, etc.), UTXO-based blockchains (e.g., Bitcoin, etc.), and/or any other suitable blockchain.

Each node 600 is preferably associated with a single validation key, but can alternatively be associated with multiple validation keys. The validation key can be: a private key, a secret, a seed phrase, a public key, an address (e.g., derived from a private key or seed phrase), and/or any other suitable information. The validation key can be used to sign blockchain messages (e.g., blockchain transactions), encrypt information, or be otherwise used. The node is preferably associated with a unique validation key within the blockchain network (e.g., no other node within the blockchain network is associated with the same validation key), but can alternatively be associated with a shared validation key within the blockchain network.

The management service 100 can contemporaneously (e.g., concurrently) manage multiple nodes 600 (e.g., multiple blockchain resources). The nodes for different blockchain resources managed by the management service can be part of the same blockchain, or be part of different blockchains. Different nodes concurrently managed by the management service are preferably associated with different validation keys, but can additionally or alternatively be associated with a shared validation key (e.g., two concurrently managed nodes can have addresses or public keys derived from the same private key). Different nodes managed by the management service can run on the same or different machines. Different nodes managed by the management service can be colocalized or remote from each other.

Each node 600 is preferably hosted by (e.g., runs on, executes on, etc.) the machine of the respective blockchain resource, but can alternatively be hosted by another machine. Each machine can concurrently host one or more nodes. Each machine can also serially host one or more nodes (e.g., for the same or different validation key). Different nodes hosted by the same machine can be connected to the same or different blockchain networks. Different nodes hosted by the same machine can execute the same or different blockchain protocol. Alternatively, each machine can only host a single node at a time.

Each node 600 is preferably an application executing on (e.g., run on) the machine, but can be otherwise hosted by the machine. Each node is preferably a blockchain client executing blockchain code, which includes the software (e.g., blockchain code, blockchain protocol, etc.) to interact with the blockchain (e.g., verify data against the blockchain's protocol's rules, synchronize with the blockchain, read blocks from the blockchain, write to the blockchain, submit transactions to the blockchain, send messages via the blockchain, participate in consensus, etc.), but can be otherwise defined. Examples of nodes that can be used include: full nodes, pruned full nodes, mining nodes, master nodes, staking nodes, light nodes, archival nodes, authority nodes, and/or any other suitable node. The nodes are preferably hosted nodes that are hosted by the system on behalf of one or more users (e.g., wherein the users share their validation keys with the system; wherein the system custodies the validation keys; etc.), but can alternatively be non-hosted nodes (e.g., wherein the user directly manages node and/or blockchain resource operation).

Each node 600 can be associated with node telemetry describing node operation metrics, such as the block height, when the node last participated in a blockchain event (e.g., consensus), network consensus times, block interval, mined blocks, block size (e.g., for each block, mean size, total size, etc.), address information (e.g., total addresses, address growth, addresses synchronized to the node, etc.), cryptographic asset supply (e.g., circulating, adjusted), entity information (e.g., active entities, receiving entities, sending entities, entity growth, etc.), network fees (e.g., total, median, mean, current mining fee, etc.), hash rate, transaction count, transaction rate, which transactions have been synchronized to the node, transfer information (e.g., volume mean, median, total, etc.), node uptime, CPU usage, memory consumption, bandwidth, block propagation, transaction throughput, and/or other metrics. The node telemetry can be natively provided by the blockchain protocol instance running on the node, be generated by the daemon running on the node's machine, and/or be otherwise determined.

However, the node 600 can be otherwise configured.

A node 600 can be associated with a node state, which can be indicative of the node's accessibility (e.g., accessible or online, inaccessible or offline, etc.), node's operation (e.g., offline, running, paused, etc.), and/or other node metric. The node accessibility can be the node's accessibility via the node's blockchain network (e.g., whether other peers can access the node, whether the node can access the blockchain, etc.), but can additionally or alternatively be via the communication network and/or via any other suitable channel. The node state can be determined by one or more: management service instances (e.g., whether the management service can access the node), other blockchain resources (e.g., whether the other blockchain resource's node can access the node), applications running on the same machine (e.g., other nodes running on the same machine, the daemon running on the machine, etc.), other nodes, and/or other systems. When the node state is determined based on information from multiple systems, the node state can be determined by: voting on the node state value, trusting a single system's node state determination, and/or otherwise determining the node state value.

The node state can be determined based on: whether the node responds to a blockchain message (e.g., message sent to the node over the blockchain); whether the node appears on a peer discovery mechanism (e.g., whether the node appears on a peerbook or registry); whether the node telemetry matches the expected telemetry values (e.g., whether the node's block height is approximately the same as other nodes in the blockchain, whether the node has participated in consensus on an expected frequency, whether the node is synchronizing new blocks from the blockchain at an expected frequency, etc.); whether messages (e.g., transactions, peer messages, etc.) sent to the blockchain using the node are detected on the blockchain (e.g., on other nodes); whether responses are received for requests sent by the node (e.g., as determined by the daemon); based on node operation metrics (e.g., as determined by the daemon); and/or otherwise determined. The node can be considered accessible (e.g., online) when a response to a request sent to the node is received, when the node telemetry satisfies a set of conditions (e.g., matches blockchain telemetry values, etc.), when messages sent using the node appear on the blockchain, when a message sent to the node appears on the node (e.g., wherein the daemon determines whether the message appears on the node), when the node has participated in a blockchain event within a predetermined timeframe (e.g., participated in consensus), when the daemon reports an accessible node state, when the node appears on a node registry (e.g., peer book), or when any other suitable condition is met. The node can be considered inaccessible (e.g., offline) when no response is received, when a response is received outside of a predetermined timeframe (e.g., after 1 minute has passed), node telemetry is outside of a threshold range of the blockchain telemetry values, when the node has not participated in blockchain events for more than a threshold period of time, and/or when any other suitable condition is met.

In a first example, the node state can be determined by sending a request to the node (e.g., ping, message, etc.) and determining whether a response is received using the blockchain protocol's peer to peer ping call or using the blockchain protocol's message passing protocol. In variants, the requesting frequency can be limited to a predetermined frequency or limited according to a rule to prevent the blockchain from flooding the node. In a second example, the node state can be determined by determining whether the node (e.g., the node's address or other identifier) appears on the blockchain's node registry. In a third example, the node state can be determined by determining whether the node is discovered or detected by other nodes on the blockchain. In a fourth example, the node state can be inferred by comparing the node telemetry against blockchain telemetry (e.g., oracle information), wherein the node is considered inaccessible when the node telemetry does not match the blockchain telemetry. In a fifth example, the node state can be inferred based on node participation in blockchain events. For example, the node can be considered inaccessible when the node does not participate in consensus at an expected frequency. In a sixth example, the node state can be determined by the daemon executing on the same machine. For example, the daemon can read the node logs and determine that the node is inaccessible when recent node events indicate that the node has failed to synchronize with the blockchain.

However, the node state can be otherwise determined.

Each node 600 is preferably connected to its respective blockchain network 300 via the respective blockchain network's peer-to-peer (P2P) layer (e.g., P2P network, blockchain transport layer, network layer, etc.), which is responsible for inter-node communication (e.g., discovery, transactions, block propagation, etc.), but can be otherwise connected to the respective blockchain network.

The blockchain network 300 preferably creates a connection path between the management service and the node (e.g., a blockchain network connection path) that is different from the connection path between the management service and the machine (e.g., an Internet network connection path, the communication network), but can alternatively leverage the same connection path. In variants, this can enable a blockchain message to reach a blockchain node via the blockchain network even though the host machine cannot be reached via the communication network, since the blockchain network can route the blockchain message around a failure point in the communication network. In a first example, the blockchain network is formed from only edge devices of the communication network. In a second example, the blockchain network is formed from both edge devices and intermediary devices of the communication network. In a third example, the blockchain network can use the communication network to communicate blockchain information, but only edge devices of the communication network are running the blockchain protocol (e.g., the blockchain code). However, the blockchain network can be otherwise related to the communication network.

In variants, the blockchain protocol can provide node messaging utilities, which enable one blockchain node to send a message to another blockchain node. Examples of node messaging utilities can include: peer-to-peer messages, gossip protocols, flooding protocols, Byzantine fault tolerance protocols, and/or other message passing protocols. Additionally or alternatively, the blockchain protocol can lack node messaging utilities. The blockchain protocol can additionally or alternatively include peer discovery utilities that enable a blockchain node to discover peers (e.g., Kademlia, Etherscan, Blockchair, blockchain APIs, blockchain SDKs, etc.). Examples of peer discovery utilities include peer books, node registries, peer lists (e.g., hardcoded peers), peer lists on boot nodes, DNS seeds, node presence broadcasting, and/or other peer discovery mechanisms. Peers can be discovered (and/or other information can be propagated through the blockchain network) using flooding methods, gossip protocols, and/or other mechanisms.

The blockchain 300 can additionally or alternatively be associated with blockchain metrics, such as block height, consensus participants, consensus times, block interval, mined blocks, block size (e.g., for each block, mean size, total size, etc.), address information (e.g., total addresses, address growth, addresses synchronized to the node, etc.), cryptographic asset supply (e.g., circulating, adjusted), entity information (e.g., active entities, receiving entities, sending entities, entity growth, etc.), network fees (e.g., total, median, mean, current mining fee, etc.), hash rate, transaction count, transaction rate, which transactions have been synchronized to the node, transfer information (e.g., volume mean, median, total, etc.), and/or other metrics. The blockchain metrics can be determined from an oracle (e.g., an offchain entity that monitors the blockchain), a set of one or more blockchain nodes (e.g., blockchain resources, unmanaged nodes, etc.), and/or otherwise determined.

However, any other suitable blockchain network can be used.

The management service 100 functions to manage one or more blockchain resources. In operation, variants of the management service can: determine the machine state of a blockchain resource, determine the node state of the blockchain resource, and manage the blockchain resource based on the machine state and the node state. For example, the management service can attempt to access the blockchain resource's machine through a first connection (e.g., the communication network), attempt to access the blockchain resource's node through a second connection (e.g., the blockchain network), and manage the blockchain resource based on the machine and node accessibility (e.g., to maximize node participation in the blockchain). The management service can additionally or alternatively determine the root cause of a node inaccessibility (e.g., whether the node is inaccessible because the node failed or the machine is inaccessible) and/or perform other analyses with the machine and node accessibility states.

The management service 100 can manage: a blockchain resource as a whole, the node of a blockchain resource, the machine of the blockchain resource, and/or any other suitable component of the blockchain resource.

The system can include one or more management services 100. The multiple management services can include a different management service for each geographic region, a different management service for each blockchain network, include redundant management services (e.g., monitoring the same or overlapping set of blockchain resources), and/or include management services that are otherwise related or unrelated. Additionally or alternatively, a single management service can manage blockchain resources with different: geographic regions, blockchain networks, computing service providers, and/or attributes. In an example, the system can include multiple management services located in different geographic regions, wherein the multiple management services can monitor the same set of blockchain resources. In this example, the true machine state and/or true node state can be determined based on the machine states and/or node states independently determined by each of the multiple management services, the metadata associated with the blockchain resource responses (e.g., the latency, the number of messages sent to the blockchain resource, etc.), and/or other information. The true machine state and/or true node state can be determined using a voting mechanism, a weighted calculation, a rule set, and/or another aggregation method. The management service is preferably centralized, but can alternatively be decentralized. The management service is preferably off chain, but can alternatively be on chain (e.g., on a blockchain of a managed node, on a different blockchain, etc.).

The management service 100 is preferably separate and distinct from the blockchain resources, but can additionally or alternatively share a machine or other resources with the blockchain resource. The management service is preferably remote from the blockchain resources (e.g., located in a separate facility, separated by a threshold distance, etc.), but can alternatively be collocated with the blockchain resources.

The management service 100 is preferably separate and distinct from the computing service providers, but can additionally or alternatively be part of or provided by a computing service provider.

The management service 100 can include or run on a machine. The machine can be part of a blockchain resource or be a separate machine.

The management service 100 can be connected to the blockchain network(s) 300 for the managed blockchain nodes. The management service can determine node accessibility via the blockchain network(s), determine blockchain information (e.g., blockchain telemetry, reference telemetry, etc.) from the blockchain, participate in the blockchain, and/or otherwise use the blockchain. The management service can include or be connected to one or more blockchain nodes for each supported blockchain (e.g., for all blockchains that the managed nodes are part of; example shown in FIG. 2), but can alternatively include or be connected to blockchain nodes for a subset of the supported blockchains, more blockchains than the supported blockchains, and/or for any other suitable set of blockchains. The blockchain node can be part of a blockchain resource managed by the management system, be a blockchain node hosted by or running alongside the management service, and/or be otherwise related to the management system. In a first variant, the management service connects directly to each blockchain. In this variant, the management service can run: only the network layer for each blockchain, run a full node (e.g., a full blockchain client), run a light node (e.g., capable of synching and reading information from the blockchain, etc.), and/or run any other suitable node. In a second variant, the management service can interact with the blockchain through the set of nodes, for the given blockchain, that the management service manages. For example, the management service can send and receive messages to and from a target node using a second node that is also managed by the management service. However, the management service can be otherwise connected to and/or utilize the blockchain network.

Alternatively, the management service 100 can not be connected to the blockchain network (e.g., be offchain or not be on part of the blockchain). In this variant, the management service can reference oracles or other blockchain monitoring systems to obtain information indicative of the node state.

The management service 100 can be connected to the communication network 200 (e.g., Internet). The management service can determine machine accessibility via the communication network and/or otherwise use the communication network. In a first variant, the management service is directly connected to the communication network. In a second variant, the management service is indirectly connected to the communication network. For example, the management service can be connected to an intermediary device, wherein the intermediary device is connected to the communication network. However, the management service can be otherwise connected to the communication network.

Alternatively, the management service 100 can not be connected to the communication network. In this variant, the management service can reference information from the daemon running on the blockchain resource, information from the computing service provider (e.g., request the machine's state from the computing service provider), and/or otherwise obtain information indicative of machine state.

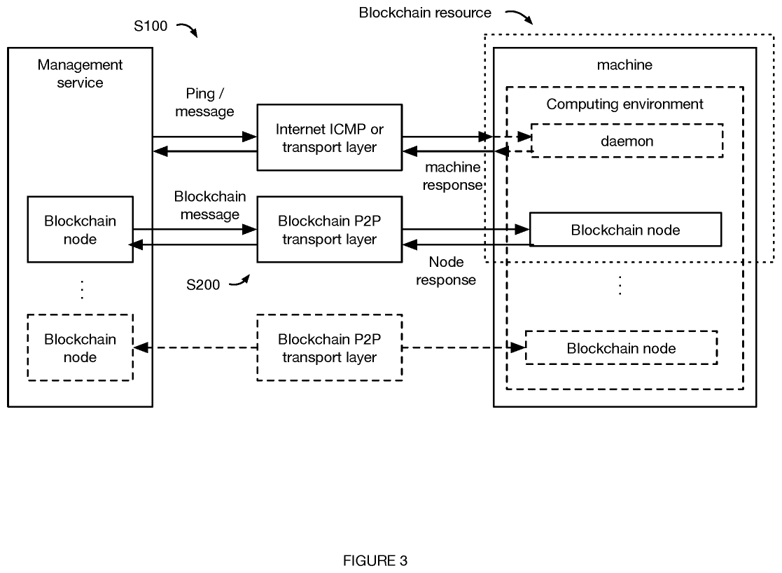

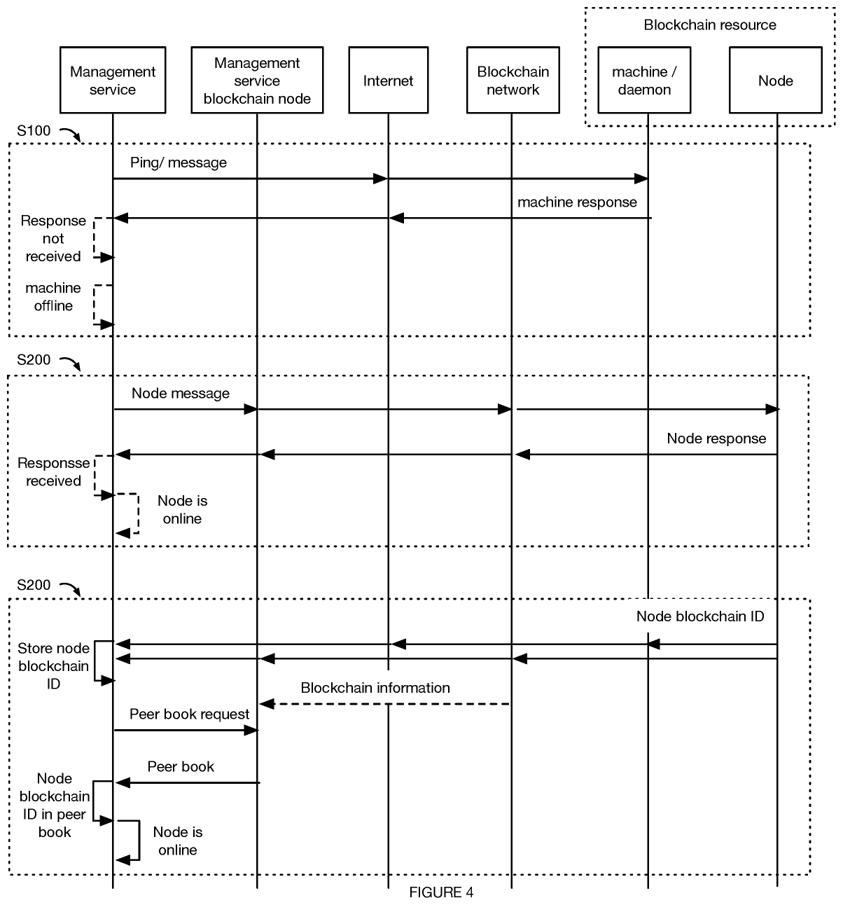

In variants, the management service 100 can determine the machine state based on messages sent to the machine. The messages are preferably lightweight calls associated with minimal payload (e.g., for the request and/or response), but can additionally or alternatively include substantive payloads (e.g., data requests). The machine messages are preferably sent over an Internet network (e.g., including a set of relays), but can alternatively be set over another communication network. In a first example, the management service can ping the machines (e.g., using a stored machine IP address and/or port number) and determine the machine state based on the ping response (e.g., whether a response was received, the latency, etc.); examples shown in FIG. 3 and FIG. 4. In a second example, the management service can maintain an open connection with the machine (e.g., an open socket connection with the machine, a TCP socket connection, a UDP socket connection, etc.), send messages to the machine over the open socket connection, and determine the machine state based on the ping response (e.g., whether a response was received, the latency, etc.). The socket connection can be maintained by the daemon executing on the machine, but can be otherwise maintained. In a third example, the management service can send a message to an application running on the machine (e.g., the daemon, nodes running on the machine), and determine the machine state based on the application response (e.g., whether a response was received).

In variants, the management service 100 can determine machine state based on machine logs (e.g., whether any events indicative of machine inaccessibility appear in the log). The machine log can be obtained from the computing service provider, sent by the daemon running on the machine, or otherwise obtained.

However, the management service 100 can otherwise determine the machine state.

In variants, the management service 100 can determine node state (e.g., blockchain client state) based on messages sent to the node, wherein the node state is determined based on the node response (e.g., whether a response was received, the latency, etc.); examples shown in FIG. 3 and FIG. 4. The node messages are preferably sent via the node's blockchain, more preferably via the blockchain's P2P network (e.g., via the blockchain's networking layer), but can alternatively be sent over another blockchain layer or through another network. The node messages are preferably P2P network calls that require a response, but can alternatively be any other suitable call. The node messages are preferably lightweight calls associated with minimal payloads (e.g., for the request and/or response), but can alternatively be a signed transaction, a substantive message (e.g., with a data payload), and/or any other suitable call.

In variants, the management service 100 can determine node state (e.g., blockchain client) based on blockchain information. The blockchain information can be received from the management service's blockchain node, from another node for the blockchain, from an offchain source (e.g., oracle, monitoring system, etc.), and/or from any other suitable source. In an example, the management service can determine the blockchain's peer book, and determine whether the node is online based on whether the node's IP address appears in the peer book (e.g., example shown in FIG. 4).

However, the management service 100 can otherwise determine the node state.

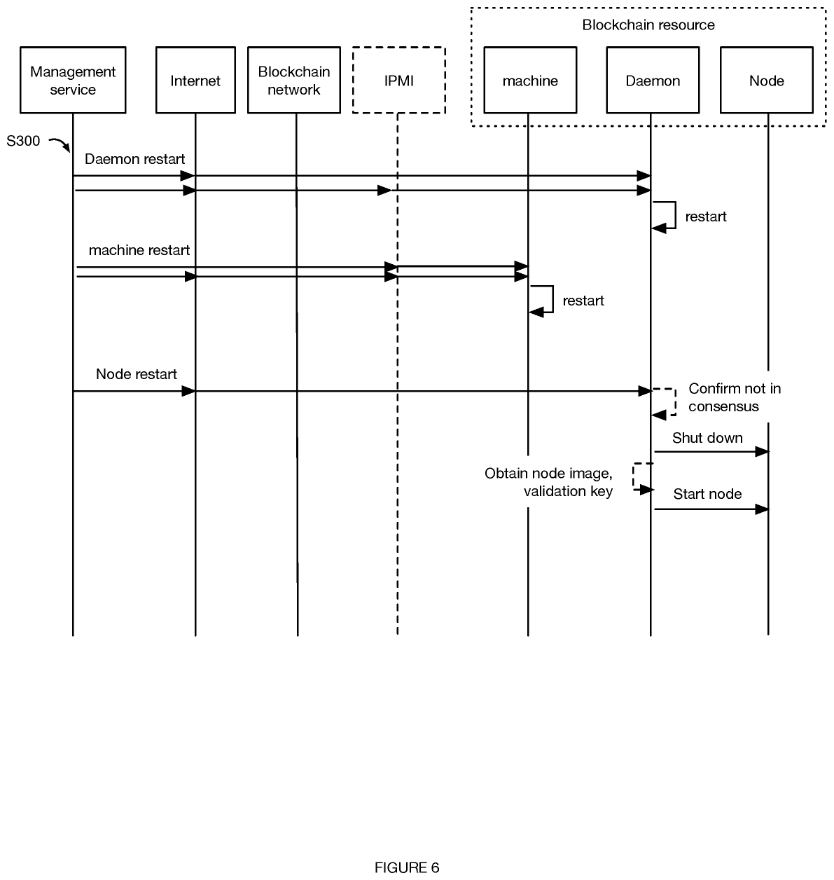

The management service 100 can control blockchain resource operation. The management service can control the blockchain resource directly or indirectly (e.g., via a daemon running on or alongside the blockchain resource component, via computing service providers, etc.). In a first variant, the management service can control blockchain resource operation by controlling the daemon executing on the machine (e.g., example shown in FIG. 6). For example, the management service can instruct the daemon to: restart the daemon, shut down the node, start the node (e.g., load a node image or snapshot, execute the node image, etc.), shut down or restart the computing environment running the node, shut down the machine, and/or otherwise interact with processes executing on the machine or interact with the machine itself. The daemon commands can be sent through the communication network, through a connection with the daemon, through the computing service provider (e.g., wherein the computing service provider can directly control the machine or send the commands to the daemon running on the machine), and/or be otherwise sent to the daemon. In a second variant, the management service can control machine operation via the out-of-band machine management system (e.g., IPMI, management interface for the computing service provider, computing service provider API, etc.) (e.g., example shown in FIG. 6). For example, the management service can instruct the machine to shut down, start, reboot, and/or perform other operations (e.g., programmatically, via an API to the IPMI, etc.). In another example, the management service can send a notification to a machine operator (e.g., on-premises operator) with manual intervention instructions. However, the management service can otherwise control blockchain resource operation.

In variants, a blockchain resource management method can include: determining a machine state of a blockchain resource S100; determining a node state of the blockchain resource S200; and managing the blockchain resource based on the machine state and the node state S300. In variants, the method can additionally or alternatively include interacting with the blockchain using the blockchain resource (e.g., sending transactions or messages using the node, reading blockchain information off the blockchain resource, etc.) after blockchain resource management S300 or at any other suitable time. The method functions to account the node state (e.g., node connectivity to the respective blockchain) in making resource management decisions.

One or more instances of the method can be executed: periodically, continuously, responsive to a monitoring event, concurrently for multiple blockchain resources, contemporaneously, and/or at any other suitable time. Examples of monitoring events can include: every consensus period, every predetermined number of consensuses, when a blockchain message sent using the node does not appear on the blockchain within a threshold period of time, prior to a blockchain interaction event (e.g., prior to sending a transaction to the blockchain using the node, prior to a predicted blockchain consensus, etc.), nonparticipation in consensus for a predetermined period of time, information (e.g., from other sources) indicative of node or machine unavailability, and/or any other suitable event. One or more processes of the method can be performed contemporaneously, serially, and/or in any other suitable order.

The method is preferably performed by a management service 100, but can alternatively be performed by any other suitable system. The method can be performed using one or more of the components discussed above, or using any other suitable component.

Determining a machine state of a blockchain resource S100 functions to determine whether the machine hosting the node (e.g., blockchain client) is operational (e.g., running) or accessible (e.g., online, connected, etc.). The machine state can be determined by one or more management services, by a machine module (e.g., utility, application, service, etc.) of the management service, by other machines, and/or by any other suitable system. The machine state can be determined: periodically, when the node state is offline, and/or at any other suitable time. The machine state can be determined using any of the methods discussed above, and/or otherwise determined. The machine state is preferably determined using an offchain or non-blockchain network, such as the communication network, or a non-blockchain protocol, such as an Internet protocol (e.g., TCP/IP, etc.), but can additionally or alternatively be determined using a blockchain network that is different from the blockchain resource node's blockchain, using the node's blockchain, and/or using any other suitable communication channel. The machine state can be determined: periodically, when the node state is offline (e.g., after a predetermined number of times; a predetermined amount of time after the node is considered to be disconnected from the blockchain network, etc.), after S200, concurrently or contemporaneously with S200, and/or at any other suitable time. The message is preferably sent at less than a predetermined frequency (e.g., at a frequency lower than the rate limit, to avoid flooding the machine, etc.), but can additionally or alternatively be sent at a predetermined frequency, at a frequency higher than a threshold, or at any other suitable time.

The machine can be considered operational when the machine is connected to a communication network, such as the Internet, when the machine can be reached by the computing service provider, when the machine logs (e.g., telemetry) indicates an available or running status (or lacks operational failure events or connection failure events), when multiple nodes (e.g., connected to the same or different blockchains) hosted by the machine are considered online or connected their respective blockchains (e.g., using S200 for each node), and/or when other conditions are met, and otherwise considered offline. The machine can be considered operational (e.g., available, running, online, accessible, connected, etc.) when the machine is executing programs or calls, when the machine is responsive (e.g., sends a response to a request), when the machine logs do not include machine failure events (e.g., disconnection events, system failure events, etc.) within a predetermined timeframe, and/or when other conditions are met. The machine can be nonoperational (e.g., unavailable, shut down, offline, inaccessible, etc.) when the machine fails to execute programs or calls, when the machine fails to respond to a request, when the machine logs include machine failure events (e.g., disconnection events, system failure events, etc.) within a predetermined timeframe, and/or when other conditions are met. However, the machine state can be otherwise determined. The machine state preferably defaults to operational and/or online (e.g., in the absence of information indicating nonoperationality or an offline state, when conflicting statuses are determined, etc.), but can additionally or alternatively default to nonoperational and/or offline.

In a first variant, determining the machine state can include sending a machine message to the machine and determining the machine state based on a machine response.

Sending a machine message to the machine functions to test whether the machine is responsive, which is indicative of whether the machine is online.

In a first embodiment, sending a message to the machine includes pinging the machine (e.g., using ICMP) (e.g., examples shown in FIG. 3 and FIG. 4).

In a second embodiment, sending a message to the machine includes sending a transport message to the machine (e.g., a TCP message, UDP message, etc.). The transport message can be sent over a connection established between the machine and the management service, or over any other suitable connection. The connection can be formed ad hoc (e.g., each time the message is to be sent), be an open connection maintained between the management service and the machine (e.g., maintained by the daemon executing on the machine), and/or over any other suitable connection.

In a third embodiment, sending a message to the machine can include sending a message to one or more application running on the machine, such as the daemon or a node. When the message is sent to a node, the node is preferably a different node from that of the blockchain resource, but can additionally or alternatively be the same node.

However, the message can be otherwise sent to the machine.

Determining the machine state based on the machine response functions to infer the machine state based on whether the machine (or an application executing on the machine) responded, based on the value of the response, based on the metadata of the response, and/or based on other response information.

In a first embodiment, the machine state can be considered operational and/or online when a response (e.g., machine response, application response, etc.) is received responsive to the message, and/or be considered offline when the machine response is not received within a predetermined period of time (e.g., a timeout duration).

In a second embodiment, the machine state can be determined based on the response value, wherein the machine response includes a machine state (e.g., as determined by the machine, the daemon, or computing service provider).

In a third embodiment, the machine state can be determined based on the latency of the response. For example, the machine state can be considered online when the response latency is less than a predetermined value (e.g., a static value or a value determined based on the attributes of the node's blockchain, such as the consensus period), and offline when the response latency is higher than a predetermined value.

In a fourth embodiment, the machine state can be determined based on the node states of the nodes hosted by the machine. For example, the machine state can be considered offline when more than a threshold number or proportion (e.g., more than 50%, 60%, 70%, 80%, 90%, 100%, etc.) of nodes hosted by the machine are offline (e.g., as determined using S200). For example, S100 can include sending messages to the set of secondary blockchain nodes (e.g., connected to the same or different blockchain from the blockchain resource's node) hosted by the machine, wherein the machine is considered online when a threshold number of secondary blockchain nodes respond to the messages. The messages can be sent over the secondary blockchain nodes' blockchains or through another communication channel.

However, the machine state can be otherwise determined based on the response to a request.

In a second variant, determining the machine state includes requesting machine operation information and inferring the machine state from the machine operation information. The machine operation information is preferably requested by the management service, but can additionally or alternatively be requested by another blockchain resource (e.g., the machine of the resource) and/or any other suitable system. The machine operation information (e.g., machine log, machine connection status, etc.) can be requested from the daemon executing on the machine, the computing service provider, network service provider (e.g., internet service provider, domain name service, etc.), and/or any other suitable resource monitoring machine operation (e.g., locally monitoring machine operation), wherein the resource returns the machine's logs. The machine state is then inferred based on the log information (e.g., the logged event categories). For example, the machine state can be “operational” when no operational or connection failure events appear within a predetermined timeframe (e.g., the last 5 minutes), and be “nonoperational” when failure events appear within the timeframe. In another example, the machine can be inaccessible when at least one network service provider (e.g., ISP) is unavailable (e.g., has an outage). However, the machine state can be otherwise determined based on machine logs.

In variants, a combination of the above methods can be used to determine machine state. For example, the machine state can be determined by determining a plurality of machine states (e.g., candidate machine states) using different methods, and aggregating the machine states into a single value (e.g., the machine state). The plurality of machine states is preferably substantially contemporaneously determined by a plurality of management services, but can alternatively be determined by a single management service, and/or otherwise determined. The machine states can be aggregated into the single value using: voting (e.g., majority, plurality, quorum, weighted voting, etc.), a weighted sum, a trained model, consensus methods (e.g., unanimous consensus is required, otherwise the machine state defaults to operational or another default state; majority consensus required; quorum required; etc.), and/or otherwise determined. The plurality of machine states are preferably contemporaneously determined (e.g., all determined within a 5 minute window, 1 minute window, within a predetermined period of time, within a time duration shorter than a consensus period for the node's blockchain, etc.), but can additionally or alternatively be concurrently determined, serially determined, determined in a predetermined order, and/or determined with any other suitable temporal relationship. Additionally or alternatively, the machine state can be determined based on a timeseries of candidate machine states determined using one or more of the above methods. For example, the machine state can be determined to be nonoperational when preceding machine states are nonoperational and no interim restart call was requested.

However, the machine state can be otherwise determined.

Determining a node state of the blockchain resource S200 functions to determine whether the node is connected to the respective blockchain network. S200 can additionally or alternatively function to determine whether the machine hosting the node is offline. The node state can be determined by one or more management services, by a node of the management service, by a blockchain module (e.g., node module) of the management service, by other nodes of the same blockchain (e.g., connected to and/or managed by the management service), and/or by any other suitable system. The node state can be determined using any of the methods discussed above, and/or otherwise determined. The node state is preferably determined using the blockchain of the node (e.g., examples shown in FIG. 3 and FIG. 4), but can alternatively be determined using the communication network (e.g., Internet), another offchain network, and/or any other suitable communication channel. The node state can be determined: periodically, when the machine state is determined to be offline (e.g., after a predetermined number of times; a predetermined amount of time after the machine is considered to be offline, etc.), after S100, concurrently or contemporaneously with S100, and/or at any other suitable time.

The node state can considered operational (e.g., online, connected, accessible, running) when: the node responds to a message (e.g., a blockchain request, a p2p message, etc.), the node logs indicate that the node has interacted with the blockchain within a predetermined timeframe (e.g., the node participated in the most recent consensus event, etc.), when transactions sent via the node have been synchronized to peers on the blockchain, the node telemetry indicates that the node is synchronizing with the blockchain, and/or when other conditions are met. The node state can be considered nonoperational (e.g., offline, inaccessible, not running, etc.) when: the node does not respond to the message, the node does not respond within a predetermined period of time, when node logs indicate that the node has not interacted with the blockchain within a predetermined timeframe (e.g., has not synchronized blocks, has not participated in consensus, etc.), when transactions sent via the node have not been synchronized to peers on the blockchain, when the node telemetry is mismatched from other nodes of the same blockchain (e.g., the block height is lower than peer block heights), and/or when other conditions are met. The node state preferably defaults to operational and/or online (e.g., in the absence of information indicating nonoperationality or an offline state, when conflicting statuses are determined, etc.), but can additionally or alternatively default to nonoperational or offline.

In a first variant, determining the node state can include sending a message to the node and determining the node state based on a node response. The node message is preferably sent using the respective blockchain (e.g., examples shown in FIG. 3 and FIG. 4), but can alternatively be sent over the Internet, another offchain network, and/or another network unrelated to the blockchain's transport layer. The node message is preferably sent using the node blockchain's transport layer, such as the P2P network (e.g., using the blockchain's transport protocol), but can additionally or alternatively be sent over a different transport path from the machine message and/or the same transport path. The message is preferably a lightweight blockchain transport protocol call that generates a response from the node, but can alternatively be a call from another layer of the blockchain (e.g., the consensus layer, a smart contract call, etc.) and/or be any other suitable call. The message is preferably sent at less than a predetermined frequency (e.g., to avoid flooding the node), but can additionally or alternatively be sent at a predetermined frequency, at a frequency higher than a threshold, or at any other suitable time. The node state can be determined based on whether a node response was received, the information within the node response, the node state included in the response (e.g., wherein the node state is determined by the node and included in the response) or other response information, the metadata of the response (e.g., the response latency), based on an aggregate of multiple node responses (e.g., received over time, received by one or more management services, etc.), and/or otherwise determined. In a first example, the node is considered online when a response is received from the node. In a second example, this variant can include: determining the node response latency, comparing the node response latency with the expected latency for the respective blockchain resource's geographic region, determining an online node state when the latency is less than the expected latency, and determining an offline node state when the latency is more than the expected latency. The node response latency can be: measured, obtained from metadata provided by the blockchain's P2P network (e.g., received alongside the response, queried from the blockchain, etc.), and/or otherwise determined. In a third example, this variant can include requesting blockchain information from the node, comparing the returned information (e.g., payload) against a set of expected information (e.g., from an oracle, from one or more other nodes of the blockchain), determining offline node state when the information is valid (e.g., substantially matches the expected information), and determining an offline node state when the information is invalid (e.g., is old, does not substantially match the expected information). However, the node state can be otherwise determined based on a node response.

In a second variant, S200 can include: determining the node's blockchain peer identifier, obtaining the peer information (e.g., peer registry, peer book, etc.) for the node's blockchain, determining that the node is online when the peer identifier appears within the peer information, and determining that the node is offline when the peer identifier does not appear within the peer information (e.g., example shown in FIG. 4). The node's peer identifier can be obtained from: the node itself, the machine hosting the node (and/or the daemon), from the blockchain (e.g., from a prior monitoring epoch), and/or otherwise obtained. The node's peer identifier can be: a blockchain address (e.g., derived from the user's private key or validation key), an IP address, an IP address and port number combination, and/or any other suitable identifier. The peer information can be: requested from the blockchain (e.g., by the management service's node for said blockchain), requested from the blockchain service's node (e.g., using the blockchain API or SDK), requested from a boot node, received from an offchain source (e.g., an oracle, a monitoring system such as Grafana or Prometheus, etc.), and/or otherwise determined.

In a third variant, S200 can include: connecting directly to the node (e.g., from the management service's blockchain node, using the blockchain protocol) with the management service, monitoring the node connection, and determining node status based on the connection state and/or metadata. For example, this can include determining that the node is online when the node is still connected, and determining that the node is offline when the node is disconnected.

In a fourth variant, S200 can include requesting node information from a monitoring system (e.g., Grafana, Prometheus, etc.), wherein the monitoring system can determine node failure.

In a fifth variant, S200 can include requesting node telemetry from the node, obtaining blockchain network metrics, and determining the node state based on a comparison between the node telemetry and the blockchain network metrics, wherein the node can be considered offline when the node telemetry is substantially mismatched from the blockchain network metrics, and considered online when the node telemetry substantially matches the blockchain network metrics (e.g., all values match, values for a predetermined set of metrics match within a predetermined error threshold, etc.). For example, the node can be considered offline when the node's block height is lower (e.g., shorter) than the blockchain's block height. The node telemetry can be obtained from the node using the communication network (e.g., Internet) or other offchain communication channel (e.g., wherein the daemon running alongside the node can determine and send the node telemetry), but can additionally or alternatively be determined using the blockchain or other communication channel. The blockchain network metrics can be obtained from an oracle, a blockchain monitoring tool (e.g., Ethstats, Hyperledger Explorer, etc.), one or more other nodes connected to the same blockchain, and/or otherwise obtained.

In variants, a combination of the above methods can be used to determine node state. For example, the node state can be determined by determining a plurality of node states (e.g., candidate node states) using different methods (e.g., by requesting a response from the node via the blockchain and evaluating node telemetry, etc.), and aggregating the node states into a single value (e.g., the node state). The plurality of node states is preferably substantially contemporaneously determined by a plurality of management services, but can alternatively be determined by a single management service, and/or otherwise determined. The node states can be aggregated into the single value using: voting (e.g., majority, plurality, quorum, weighted voting, etc.), a weighted sum, a trained model, consensus methods (e.g., unanimous consensus is required, otherwise the machine state defaults to operational or another default state; majority consensus required; quorum required; etc.), and/or otherwise determined. The plurality of node states are preferably contemporaneously determined (e.g., all determined within a 5 minute window, 1 minute window, within a predetermined period of time, within a time duration shorter than a consensus period for the node's blockchain, etc.), but can additionally or alternatively be concurrently determined, serially determined, determined in a predetermined order, and/or determined with any other suitable temporal relationship. Additionally or alternatively, the node state can be determined based on a timeseries of candidate node states determined using one or more of the above methods. For example, the node state can be determined to be nonoperational when preceding node states are nonoperational and no interim restart call was requested.

However, the node state can be otherwise determined.

Managing the blockchain resource based on the machine state and the node state S300 functions to selectively restart the node or the systems supporting the node (e.g., machine, computing environment, etc.) of the blockchain resource while mitigating adverse issues on the blockchain. In a specific example, S300 selectively restarts the hardware (e.g., machine, server) or software (e.g., node, blockchain client, etc.) based on the machine state and node state. The blockchain resource is preferably managed by one management services, but can alternatively be managed by multiple management services (e.g., using a voting or other instruction aggregation mechanism), by a user, and/or otherwise managed. The blockchain resource is preferably managed based on the machine state and the node state determined in S100 and S200, respectively, but can additionally or alternatively be managed based on any other suitable information. The blockchain resource can be managed based on a single machine state and a single node state (e.g., the most recent machine and node states), be managed based on multiple machine and node states (e.g., from multiple management services, from different evaluation times, etc.), and/or be managed based on any other suitable set of data.

Managing the blockchain resource can include: shutting down the machine (e.g., which shuts down all nodes hosted by the machine), restarting the machine, shutting down or restarting the computing environment hosting the node (e.g., which shuts down all nodes running in the computing environment but not those on the machine running on a different computing environment), shutting down and/or restarting the daemon running on the machine (e.g., with little to no effect on machine operation or node operation), shutting down the node (e.g., with little to no effect on machine operation and/or the execution of other nodes hosted by the machine), restarting the node on the same machine, restarting the node on a different machine, and/or otherwise managing the blockchain resource. Machine-level operations are preferably controlled programmatically via the daemon, but can additionally or alternatively be programmatically controlled via the machine database's IPMI, manually controlled by a machine operator (e.g., via notifications sent to the machine operator), and/or otherwise controlled. Node-level operations are preferably controlled (e.g., programmatically) via the daemon, but can be otherwise controlled. Operation commands can be communicated using the communication network (e.g., Internet), using a secondary network (e.g., telephone, peer-to-peer network, etc.), using a blockchain network (e.g., wherein the machine operation message is relayed to the daemon through a node executing on the machine, via the respective blockchain), and/or using any other suitable communication path.

Blockchain resource management can be performed using a set of rules, heuristics, a trained machine learning model (e.g., trained based on node penalization data, etc.), an optimization, and/or other decision-making architecture. The decision-making architecture can be determined by a user (e.g., be a user preference, such as wait a predetermined period of time or a predetermined number of failed pings before restarting the machine or node), be learned (e.g., based on historical blockchain resource operation instructions and node blockchain performance, etc.), be optimized (e.g., to maximize the probability of node consensus participation, etc.), be a predetermined decision tree, and/or otherwise determined. The blockchain resource can be automatically managed, managed after proposed action confirmation by a user (e.g., wherein a notification can be sent to the user before machine restart and/or node restart, etc.), and/or otherwise managed.

In examples, when the node is nonoperational (e.g., offline, unavailable, disconnected, etc.) but the machine is operational (e.g., online, connected, available, etc.), the node can be restarted. In examples, this can include sending (e.g., via the open socket connection, via the Internet, etc.) a node restart instruction from the management service to the machine, more preferably to the daemon executing on the machine but alternatively another utility, to shut down and restart the node, wherein the machine (e.g., daemon, other utility, etc.) can shut down and restart the node on the same machine while the machine remains online (e.g., example shown in FIG. 6). The daemon can optionally validate that the node is not in consensus (e.g., is not a validator, etc.) or actively participating in a blockchain event before shutting down the node. Restarting the node can include: shutting down the node, downloading a new version of the node code, and provisioning a node using the new node code and the user's private key (or information derived therefrom); shutting down the node, retrieving a prior snapshot or image of the node (e.g., associated with an online state), loading the snapshot or image of the node, and synchronizing the blockchain from the snapshot or image; shutting down the node and provisioning a node using the stored node code and the user's private key (or information derived therefrom); and/or otherwise restarting the node. In examples, when the node is offline (e.g., initially determined to be offline; remains offline after node restart, wherein restart is confirmed by the daemon; etc.), the node can be shut down on the original machine and restarted on a different machine (e.g., wherein the management service instructs the daemon for the original machine to shut down the node, wait for confirmation that the node is shut down, then instruct the daemon for the new machine to start the node). The other machine can be within the same computing service provider facility, a different facility, be from another computing service provider, and/or be otherwise related to the first machine. Node provisioning on the other machine (e.g., using the same validation keys) can be performed automatically, after confirmation from the user (e.g., based on user preferences), and/or at any other suitable time. However, the node can be otherwise restarted. Additionally or alternatively, the computing environment hosting the node can be restarted. However, the node can be otherwise managed when the node is nonoperational but the machine is operational.

In a second example, when the machine is nonoperational (e.g., offline, unavailable, etc.) and the node is determined to be offline, the machine or computing environment can be restarted (e.g., using a soft restart, hardware restart, failover, and/or other restart mechanism) or shut down, wherein the nodes can be restarted on the same or different machine. For example, the management service can send a message to the machine via the machine's IPMI to restart the machine (e.g., example shown in FIG. 6); send a message to a machine operator to hard-restart the machine; and/or otherwise facilitate machine restart. When the machine hosts multiple nodes, the machine is preferably shut down or restarted when a set of nodes hosted by the machine (e.g., all nodes, majority of the nodes, user-prioritized nodes, etc.) are contemporaneously determined to be offline, but can additionally or alternatively be shut down or restarted when a single node hosted by the machine is offline. When the machine hosts multiple nodes, the nodes that are still online can be confirmed to not be participating in a blockchain event (e.g., consensus) before shutting down or restarting the machine. However, the machine can be otherwise managed when the machine is offline and the node is offline.

In a third example, when the machine is nonoperational (e.g., offline, unavailable, etc.) and the node is determined to be online, the machine is not shut down or restarted immediately. In this situation, the: daemon can be restarted (e.g., via the IPMI, self-restarted when the daemon cannot reach the management service or does not receive the management service heartbeat, etc.) (e.g., example shown in FIG. 6); the management service can wait for the machine to come back online; the management service can wait until the probability of the node participation in a blockchain event (e.g., consensus) falls below a threshold before restarting; the management service can wait until the probability of the all hosted node participation in a blockchain event (e.g., consensus) on their respective blockchains falls below a threshold before restarting; and/or other actions can be taken. Confirming that a node is not in consensus and/or not going to enter consensus can be done deterministically or probabilistically (e.g., by the management service, node module, etc.). In a first example, confirming that the node is not going to enter consensus includes verifying that the node identifier is not on the list of nodes entering consensus, wherein the list of nodes entering consensus can be determined by the management service's node for the respective blockchain. In a second example, confirming that the node is not going to enter consensus is determined based on the block height and/or time point in the consensus cycle (e.g., wherein a low number of blocks since the last consensus or just completing the last consensus cycle can be associated with a low probability of the node entering consensus). However, future node participation in consensus can be otherwise determined. For example, the daemon can be restarted, and when the machine is still offline after a daemon restart, the method can include: optionally confirming that the node is not in consensus or not going to enter consensus, optionally confirming that other nodes hosted by the machine is not in consensus or not going to enter consensus, and rebooting the machine when the node and/or other hosted nodes are not in or entering consensus. However, the blockchain resource can be otherwise managed when the machine is unavailable but the node is available.

In variants, the method can optionally include tracking the latency for a geographic region. This information can be used to determine whether a node response latency is within a typical (e.g., expected) range, whether a machine response latency is within a typical (e.g., expected) range, be used to recommend geographic regions for blockchain resource provisioning to a user (e.g., recommend geographic regions with the lowest latency, recommend geographic regions with the highest sparsity, recommend geographic regions with the highest estimated return based on latency and sparsity, etc.), and/or otherwise used. The latency can include: node response latency (e.g., for nodes of a given blockchain), machine response latency (e.g., for nodes in a given geographic region, provided by a given data center provider, etc.), and/or any other suitable latency. The latency can be collected using the node response metadata, the machine response metadata, and/or any other suitable information. However, the latency can be otherwise determined.

In variants, once the machine and node are operational (e.g., online, available, etc.), the blockchain resources can be used to interact with the respective blockchains. For example, a system (e.g., the management service, a system including the management service, etc.) can receive blockchain transactions from a user (e.g., offchain) and send the blockchain transaction to a node of a managed blockchain resource (e.g., offchain, via the daemon, etc.), wherein the blockchain resource can broadcast the transaction to the respective blockchain. In another example, a user can directly access the managed blockchain resource and interact with the respective blockchain using said blockchain resource. However, the blockchain resource can be otherwise used.

All references cited herein are incorporated by reference in its entirety, except to the extent that the incorporated material is inconsistent with the express disclosure herein, in which case the language in this disclosure controls.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A method for managing a blockchain resource comprising a blockchain node hosted by a processing system, comprising:
determining the processing system connectivity to a communication network;
determining the blockchain node connectivity to a blockchain distinct from the communication network; and
managing the blockchain resource based on the processing system connectivity and the blockchain node connectivity, comprising:
restarting the processing system when the processing system is offline and the blockchain node is offline;
not restarting the processing system when the processing system is offline and the blockchain node is online; and
restarting the blockchain node when the processing system is online and the blockchain node is offline.

2. The method of claim 1, wherein the method is performed by a system remote and distinct from the blockchain resource.

3. The method of claim 1, wherein the processing system connectivity and the blockchain node connectivity are determined contemporaneously.

4. The method of claim 1, wherein determining the processing system connectivity comprises sending an Internet Control Message Protocol (ICMP) request to the processing system via the communication network.

5. The method of claim 1, wherein determining the blockchain node connectivity comprises sending a blockchain message to the blockchain node via the blockchain.

6. The method of claim 1, wherein determining the blockchain node connectivity comprises comparing telemetry from the blockchain node and a secondary blockchain node connected to the blockchain.

7. The method of claim 6, wherein the blockchain node is offline when the telemetry from the blockchain node comprises a lower block height than the telemetry from the secondary blockchain node.

8. The method of claim 1, wherein determining the blockchain node connectivity comprises determining whether the blockchain node appears in a peerbook for the blockchain.

9. The method of claim 1, wherein the processing system contemporaneously hosts a set of secondary blockchain nodes in addition to the blockchain node, wherein the processing system connectivity is determined based on the secondary blockchain node connectivity to secondary blockchains.

10. The method of claim 1, wherein restarting the blockchain node comprises loading a previous snapshot of the blockchain node.

11. The method of claim 1, further comprising confirming that the node is not in blockchain consensus before restarting the processing system.

12. A system for monitoring a plurality of blockchain resources, each comprising a blockchain node hosted by a processing system, the system comprising:
a machine module configured to determine an accessibility of a processing system of a blockchain resource of the plurality via a communication network;
a node module configured to determine the blockchain node accessibility via a blockchain distinct from the communication network; and
a management service that is configured to manage the blockchain resource based on the processing system accessibility and the blockchain node accessibility, comprising:
restarting the processing system when the processing system is inaccessible and the blockchain node is inaccessible; and
not restarting the processing system when the processing system is inaccessible and the blockchain node is accessible.

13. The system of claim 12, wherein the communication network comprises an Internet Protocol (IP) network, and wherein determining the processing system accessibility comprises sending an internet control message protocol (ICMP) echo request to the processing system.

14. The system of claim 12, wherein the processing system concurrently hosts multiple blockchain nodes, each connected to a different blockchain, wherein determining the processing system accessibility comprises sending blockchain messages to the multiple blockchain nodes via the respective blockchains.

15. The system of claim 12, wherein the node module further determines whether a blockchain node hosted by the processing system is in consensus, wherein an inaccessible processing system is restarted after the hosted blockchain nodes are not in consensus.

16. The system of claim 12, wherein determining the blockchain node accessibility comprises sending a blockchain message to a blockchain node via the blockchain network, wherein the blockchain node is accessible when a response to the blockchain message is received from the blockchain node.

17. The system of claim 16, wherein determining processing system accessibility comprises sending a network message to the machine hosting the blockchain node via the communication network, wherein the processing system is accessible when a response to the network message is received from the processing system.

18. The system of claim 12, wherein determining the blockchain node accessibility comprises comparing a block height from the blockchain node to a reference block height for the blockchain.

19. The system of claim 12, wherein determining the blockchain node accessibility comprises determining whether the blockchain node appears in a peerbook for the blockchain.

20. The system of claim 12, further comprising a daemon running on the processing system, wherein the daemon is configured to control node operation.
